(19) United States
(12) Patent Application Publication
(10) Pub. No.: US 2026/0201717 A1
(43) Pub. Date: Jul. 16, 2026

(54) POOL MAP GENERATION METHOD, STORAGE MEDIUM, AND POOL ROBOT

(71) Applicant: XINGMAI INNOVATION TECHNOLOGY (SUZHOU) CO., LTD., Suzhou (CN)

(72) Inventor: Shengle WANG, Suzhou (CN)

(73) Assignee: XINGMAI INNOVATION TECHNOLOGY (SUZHOU) CO., LTD., Suzhou (CN)

(21) Appl. No.: 19/564,129

(22) Filed: Mar. 11, 2026

Related U.S. Application Data
(63) Continuation of application No. PCT/CN2023/134134, filed on Nov. 24, 2023.

(30) Foreign Application Priority Data
Sep. 13, 2023 (CN) 2023111839226

(51) Int. Cl. E04H 4/16; G05D 1/224; G05D 1/246; G05D 1/648; G05D 105/10; G05D 107/00; G05D 109/30

(52) U.S. Cl. CPC E04H 4/1654; G05D 1/2246; G05D 1/246; G05D 1/648; G05D 2105/10; G05D 2107/29; G05D 2109/38

(57) ABSTRACT

This application provides a pool robot control method. The method includes: receiving a selection instruction for a three-dimensional map of a pool, where the three-dimensional map of the pool includes a bottom model of the pool, a wall model of the pool, and a water surface model; determining a target region in the pool based on the selection instruction; and controlling a pool robot to move to the target region and clean the target region.

### CROSS-REFERENCE TO RELATED APPLICATIONS

This application is a continuation of International Patent Application No. PCT/CN 2023/134134, filed with the World Intellectual Property Organization on Nov. 24, 2023, which claims priority to: Chinese Patent Application No. 202311183922.6, filed with the China National Intellectual Property Administration on Sep. 13, 2023 and entitled “POOL MAP GENERATION METHOD, STORAGE MEDIUM, AND POOL ROBOT”, which is incorporated herein by reference in its entirety.

### TECHNICAL FIELD

Embodiments of this application relate to the field of robots, and specifically, to a pool map generation method, a storage medium, and a pool robot.

### BACKGROUND

With improvement in living standards of people, there are pools for ornament or swimming in more and more families or amusement parks, leading to emergence of pool robots configured to clean the pools. The pool robot can automatically clean a bottom, a side wall, and a water surface of the pool, providing great convenience for life of people.

Currently, the pool robot on the market only has some basic cleaning functions for the pool (for example, a swimming pool). However, a user actually expects more than just that. To provide better user experience, providing a more realistic pool display effect has also become a user requirement. However, there is no method for realistically three-dimensionally displaying a pool in a related technology.

An effective solution to resolve the above problem in the related technology has not been proposed.

### SUMMARY

Embodiments of this application provide a pool map generation method, a storage medium, and a pool robot, to at least resolve a problem in a related technology that a pool cannot be realistically three-dimensionally displayed.

According to one embodiment of this application, a pool map generation method is provided. The method includes: mapping a plurality of pieces of two-dimensional coordinate information to a three-dimensional map to obtain target three-dimensional coordinate information, where each piece of two-dimensional coordinate information is grid information of a target position point in a pool, where the grid information is pre-detected by a pool robot; generating a bottom model of the pool in the three-dimensional map of the pool based on bottom surface information of the pool included in the target three-dimensional coordinate information; and generating a wall model and a water surface model of the pool in the three-dimensional map of the pool based on the bottom surface information.

According to another embodiment of this application, a pool map generation apparatus is provided. The apparatus includes: a mapping module configured to map a plurality of pieces of two-dimensional coordinate information to a three-dimensional map to obtain target three-dimensional coordinate information, where each piece of two-dimensional coordinate information is grid information of a target position point in a pool, where the grid information is pre-detected by a pool robot; a first generation module configured to generate a bottom model of the pool in the three-dimensional map of the pool based on bottom surface information of the pool included in the target three-dimensional coordinate information; and a second generation module configured to generate a wall model and a water surface model of the pool in the three-dimensional map of the pool based on the bottom surface information.

According to still another embodiment of this application, a computer-readable storage medium is further provided. The computer-readable storage medium stores a computer program. When the computer program is run, steps in any one of the method embodiments are performed.

According to still another embodiment of this application, a pool robot is further provided. The pool robot includes a memory and a processor. The memory stores a computer program. The processor is configured to: when executing the computer program, perform steps in any one of the method embodiments.

### BRIEF DESCRIPTION OF THE DRAWINGS

FIG. 1 is a block diagram of a hardware structure of a mobile terminal for performing a pool map generation according to an embodiment of this application;

FIG. 2 is a flowchart of a pool map generation method according to an embodiment of this application;

FIG. 3-1 is a schematic diagram 1 of a pool according to an embodiment of this application;

FIG. 3-2 is a line diagram of a schematic diagram 1 of a pool according to an embodiment of this application;

FIG. 4-1 is a schematic diagram 2 of a pool according to an embodiment of this application;

FIG. 4-2 is a line diagram of a schematic diagram 2 of a pool according to an embodiment of this application;

FIG. 5-1 is a schematic diagram 3 of a pool according to an embodiment of this application;

FIG. 5-2 is a line diagram of a schematic diagram 3 of a pool according to an embodiment of this application;

FIG. 6 is an overall flowchart according to an embodiment of this application; and

FIG. 7 is a block diagram of a structure of a pool map generation apparatus according to an embodiment of this application.

### DETAILED DESCRIPTION OF THE EMBODIMENTS

Embodiments of this application are described in detail in the following with reference to the accompanying drawings.

It should be noted that in this specification, claims, and the accompanying drawings of this application, the terms “first”, “second”, and the like are intended to distinguish between similar objects but do not necessarily indicate a specific order or sequence.

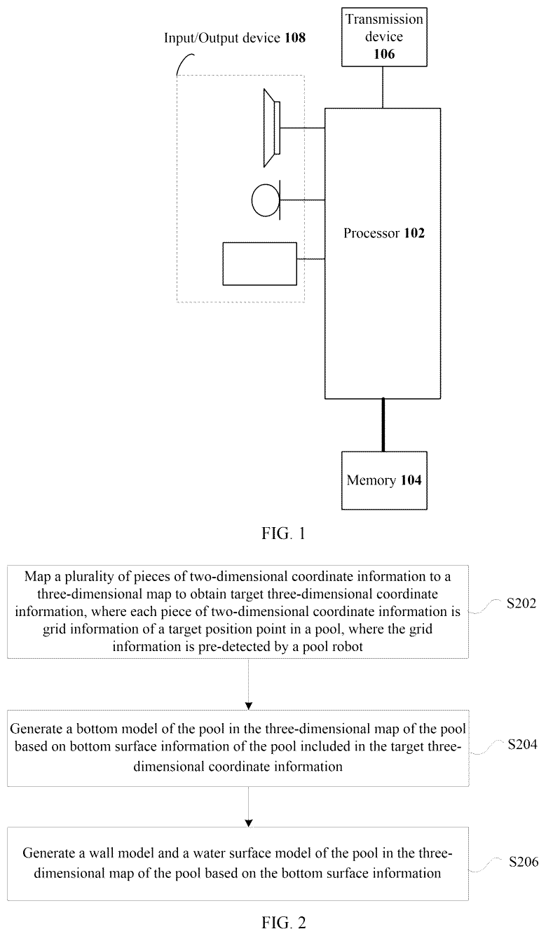

The method provided in embodiments of this application may be performed by a mobile terminal, a computer terminal, or a similar computing apparatus. An example in which the method is performed by the mobile terminal is used. FIG. 1 is a block diagram of a hardware structure of a mobile terminal for performing a pool map generation method according to an embodiment of this application. As shown in FIG. 1, the mobile terminal may include one or more (only one processor is shown in FIG. 1) processors 102 (the processor 102 may include, but is not limited to, a processing apparatus such as a microprocessor unit MPU or a field-programmable gate array FPGA) and a memory 104 configured to store data. The mobile terminal may further include a transmission device 106 with a communication function and an input/output device 108. A person skilled in the art may understand that the structure shown in FIG. 1 is only an example and does not constitute any limitation on the structure of the mobile terminal. For example, the mobile terminal may alternatively include more or fewer components than those shown in FIG. 1 or have a configuration different from that shown in FIG. 1.

The memory 104 may be configured to store a computer program, for example, a software program of application software and modules, for example, a computer program corresponding to the pool map generation method in embodiments of this application. The processor 102 executes the computer program stored in the memory 104 to execute various functional applications and data processing, that is, to implement the above method. The memory 104 may include a high-speed random access memory or a non-volatile memory, for example, one or more magnetic storage apparatuses, a flash memory, or another non-volatile solid-state memory. In some examples, the memory 104 may further include memories that are remotely disposed relative to the processor 102, and these remote memories may be connected to the mobile terminal through a network. Examples of the foregoing network include, but are not limited to, the Internet, an intranet, a local area network, a mobile communication network, and a combination thereof.

The transmission device 106 is configured to receive or send data through a network. Specific examples of the network may include a wireless network provided by a communication provider of the mobile terminal. In one example, the transmission device 106 includes a network interface controller (Network Interface Controller, NIC) that may be connected to other network devices through a base station to communicate with the Internet. In one example, the transmission device 106 may be a radio frequency (Radio Frequency, RF) module configured to communicate with the Internet in a wireless manner.

In embodiments of this application, the pool robot may be a pool cleaning robot. When the pool robot first enters a pool to perform a task, the pool robot needs to re-generate a three-dimensional map of the pool after being reset, or the pool robot is in other scenarios in which the three-dimensional map of the pool needs to be generated, the pool map generation method in embodiments of this application may be used to generate the three-dimensional map of the pool. The generated three-dimensional map of the pool can be displayed on an interface of an application APP of a mobile device, and a user can observe a three-dimensional effect of the pool through the APP. In addition, the user can control, through the APP, the pool robot to perform a task in a specific region of the pool and observe an operation path of the pool robot on the APP. The following describes how a pool map is generated in this application.

FIG. 2 is a flowchart of a pool map generation method according to an embodiment of this application. As shown in FIG. 2, the method includes the following steps.

Step S202: Map a plurality of pieces of two-dimensional coordinate information to a three-dimensional map to obtain target three-dimensional coordinate information, where each piece of two-dimensional coordinate information is grid information of a target position point in a pool, where the grid information is pre-detected by a pool robot.

Step S204: Generate a bottom model of the pool in the three-dimensional map of the pool based on bottom surface information of the pool included in the target three-dimensional coordinate information.

Step S206: Generate a wall model and a water surface model of the pool in the three-dimensional map of the pool based on the bottom surface information.

The above steps may be performed by a controller disposed inside the pool robot, a controller, a control system, or a processor having an association relationship with the pool robot and having data processing and signal interaction capabilities, or another processing device or processing unit having a similar processing capability.

In the above embodiment, the pool robot can clean the pool. The target pool is, but is not limited to, a swimming pool, an ornamental reservoir, a wild pool, or the like. The target position point may be a position point in the pool detected by the pool robot when the pool robot constructs a map of the pool and include a position point on the bottom (corresponding to the bottom surface) of the pool, a position point on a wall of the pool, and a position point on an object in the pool (for example, an obstacle or a landscape in the pool). The pool robot may construct the map of the pool before performing cleaning or during a cleaning operation.

The above three-dimensional map includes the target three-dimensional coordinate information obtained by performing mapping based on raster data (grid data) obtained when the pool robot currently moves in the pool, and the three-dimensional map of the pool may be obtained by performing various rendering operations based on the target three-dimensional coordinate information. The above three-dimensional map may include other rendered models (for example, a model of a house and a model of a tree) in addition to the three-dimensional map of the pool. An operation trajectory of the pool robot in the map corresponds to a trajectory line generated in real time when the pool robot moves in the pool. In addition, the above three-dimensional map may alternatively be a pre-constructed map. In addition, after the pool robot is repositioned to determine coordinates of the pool robot, the trajectory line generated in real time when the pool robot moves may be added to the three-dimensional map of the pool. An occasion for constructing the three-dimensional map is not limited in this application.

According to the above embodiment, because when the three-dimensional map of the pool is generated, an internal three-dimensional structure of the pool and three-dimensional display of the wall of the pool are comprehensively considered, the displayed pool more closely resembles the actual pool. This effectively resolves a problem in a related technology that a pool cannot be realistically three-dimensionally displayed and improves visual experience of a user.

In an optional embodiment, the generating a bottom model of the pool in the three-dimensional map of the pool based on bottom surface information of the pool included in the target three-dimensional coordinate information includes: connecting coordinate points corresponding to position information of adjacent edges included in the bottom surface information; generating a bottom surface edge connection graph of the pool in the three-dimensional map of the pool based on a connection result; and rendering the bottom surface edge connection graph to obtain the bottom model.

In the above embodiment, the bottom surface information may include position information of an edge located near a contour of the bottom of the pool, position information of a central region of the bottom of the pool, and position information of a region located near the central region of the bottom of the pool. When a bottom surface connection graph is constructed, coordinate points corresponding to position information of edges of the bottom of the pool may be connected to obtain the bottom surface connection graph. Because a quantity of position points pre-collected by the pool robot is limited, if transition between some of lines in the connection graph is abrupt, a joint between abrupt line segments may be smoothed to obtain a smooth line corresponding to the edge of the bottom of the pool. In addition, the edge of the bottom of the pool may be straight or curved, and a type of the edge may be determined based on a shape of a line segment formed after edge points are connected. For example, when connection lines of the edge points cannot form a straight line segment, a connection line segment before the connection lines that cannot form a straight line segment is considered as a line segment of a straight edge. When a series of edge points cannot be connected to form a straight line, data points from an initial data point and a final data point (namely, the series of edge points) are marked as data of an irregular curved line, and the data of the irregular curved line serves as a piece of data. In the above embodiment, the bottom edge connection graph of the pool may be rendered by using a Three. js technology or another technology.

In an optional embodiment, the generating a water surface model of the pool in the three-dimensional map of the pool based on the bottom surface information includes: obtaining a distance between each first position point on a water surface and a bottom surface of the pool, where the distance is pre-detected by the pool robot; generating a water surface connection graph of the pool in the three-dimensional map of the pool based on the distance between each first position point and the bottom surface of the pool; and rendering the water surface connection graph to obtain the water surface model.

In the above embodiment, position information, of each target position point, pre-detected by the pool robot includes coordinate information of each target position point. Generally, coordinate information, of a position point, detected by the pool robot includes coordinate point information in a two-dimensional coordinate system, namely, coordinate values in a world coordinate system in which the pool robot is currently located. In addition, the pool robot may determine depth information of each position point or a distance between each position point and a reference surface (for example, the bottom of the pool) by using a depth detection sensor (for example, a radar sensor, an infrared sensor, and a pressure sensor) disposed inside the pool robot or based on a specific algorithm. Therefore, a pre-detected depth (or a height relative to the reference surface) of the target position point is actually recorded in the pool robot. In this way, the information of each position point can be completely mapped to three axes of the three-dimensional map.

In the above embodiment, the distance between each first position point and the bottom of the pool may be determined based on a depth (or a height relative to a reference surface), of each first position point on the water surface, pre-detected by the pool robot, so that some points on the water surface can be identified in the three-dimensional map. Then, a position of a part of the water surface connection graph in the three-dimensional map of the pool can be obtained by connecting the identified points, and the entire water surface connection graph can be obtained by extending the part of the water surface connection graph outward to the wall of the pool. In this way, the entire water surface connection graph can be rendered subsequently. In addition, in this embodiment, the entire water surface connection graph can also be rendered by using the Three. js technology. Certainly, all of regions between the water surface and the bottom of the pool can also be rendered as textures of a water region.

In an optional embodiment, the generating a wall model of the pool in the three-dimensional map of the pool based on the bottom surface information includes: generating an inner wall model of the pool in the three-dimensional map of the pool based on the bottom surface information; and extending the inner wall model outward in the three-dimensional map of the pool to generate the wall model of the pool in the three-dimensional map of the pool. In this embodiment, a wall of an actual pool has a certain thickness. To be closer to a shape of the actual pool, after the inner wall model of the pool is generated, the inner wall model of the pool needs to be extended outward by a certain pixel (a size of the pixel may be determined based on the actual thickness of the wall of the pool, a fixed pixel value is set, or the pixel value is set based on other conditions), to obtain a more real shape of the pool.

In an optional embodiment, the generating an inner wall model of the pool in the three-dimensional map of the pool based on the bottom surface information includes: determining an edge line of the pool in the three-dimensional map of the pool based on the bottom surface information; extending the edge line upward by a preset height to generate a wall connection graph of the pool in the three-dimensional map of the pool; and rendering the wall connection graph of the pool to obtain the inner wall model of the pool. In this embodiment, the wall model of the pool is actually attached to an edge of the bottom model of the pool. Therefore, the edge of the bottom model may be extended upward (that is, in a direction of a Z-axis of the three-dimensional coordinate system) to generate the wall connection graph of the pool. During extension, a specific extension height may be set based on an actual situation. For example, the wall model of the pool may be set to be flush with the water surface model, or the wall model of the pool may be set to be higher than the water surface model. In addition, the pool robot may pre-detect a height difference between the wall of the pool and the water surface, and then the height of the wall model of the pool is set based on the pre-detected height difference. The height of the wall model of the pool may be set in a pre-configured manner.

In an optional embodiment, the extending the inner wall model outward in the three-dimensional map of the pool to generate the wall model of the pool in the three-dimensional map of the pool includes: extending the inner wall model of the pool outward by a preset quantity of pixel points in the three-dimensional map of the pool to obtain an outer wall model of the pool; connecting a point on the inner wall model of the pool to a point on the outer wall model of the pool to form a wall gap-filling geometry; and rendering the wall gap-filling geometry to obtain the wall model of the pool. In this embodiment, each of the walls of the pool actually has a certain thickness. To make the pool presented in the three-dimensional map closer to the actual pool, the generated inner wall model of the pool may be extended outward, for example, by two pixel points, five pixel points, or another quantity of pixel points, or may be extended outward by a certain proportion (for example, 1/50 or 1/100) based on an overall width of the pool. The outward extension actually indicates performing extension along an X-axis and/or a Y-axis in a direction away from the pool. In addition, after each inner wall model of the pool is extended outward, there are gaps between the wall models of the pool. In this case, these gaps need to be filled. For example, when the inner wall models of the pool are formed by connecting a plurality of line segments, adjacent line segments of the inner wall models of the pool are extended outward to form two outward extended line segments, each of two outward extended line segments has an endpoint close to an intersection point of the adjacent line segments, and the intersection point and two endpoints are connected to form a triangle. Then, the triangle is extended from the bottom of the pool to the top of the pool to obtain the wall gap-filling geometry. Optionally, after connection, smooth transition processing may be further performed on the geometry formed through connection, so that the walls of the pool can be smoothly connected. For example, a position point on the outer wall model of the pool may be offset by one position and then connected to a corresponding point on the inner wall model of the pool, and a final position point on the outer wall model is connected to an initial position point on the inner wall model to form filling regions corresponding to walls of the pool. In this case, the walls look uniform in width and smoothly connected. In this embodiment, the wall models of the pool may be split and rendered through data splitting (that is, data belonging to different walls of the pool and the bottom of the pool is distinguished by using specific code or a specific program, to determine position points corresponding to a wall of the pool or the bottom of the pool). After the wall models of the pool are split, in a subsequent work process, a region on a specific wall model of the pool or the bottom model of the pool may be individually selected, and the robot may be controlled to clean the region.

In an optional embodiment, after the wall model of the pool is generated, the method further includes: connecting points on an outer side of the wall model of the pool to form an outer contour of a wall of the pool in the three-dimensional map of the pool; hollowing out the outer contour of the wall of the pool in the three-dimensional map of the pool to form a ground geometry located around the pool; and rendering the ground geometry to obtain a ground model located around the pool. In this embodiment, there may be further a lawn or a beach around the pool. To make a display effect of the pool closer to an actual effect, a corresponding texture may be rendered for a periphery of the pool. To avoid rendering a same texture for the pool and the periphery of the pool when the periphery of the pool is rendered, the pool is hollowed out in embodiments of this application, so that only the periphery of the pool is rendered. When the ground around the pool is constructed, a manner of connecting points on an outer side and then performing hollowing may be used, or a wall top surface model of the pool may be extended outward in a manner similar to a manner of extending the inner wall model of the pool outward. In addition, the extended ground may be flush with the wall top surface model of the pool or lower than the wall top surface model of the pool.

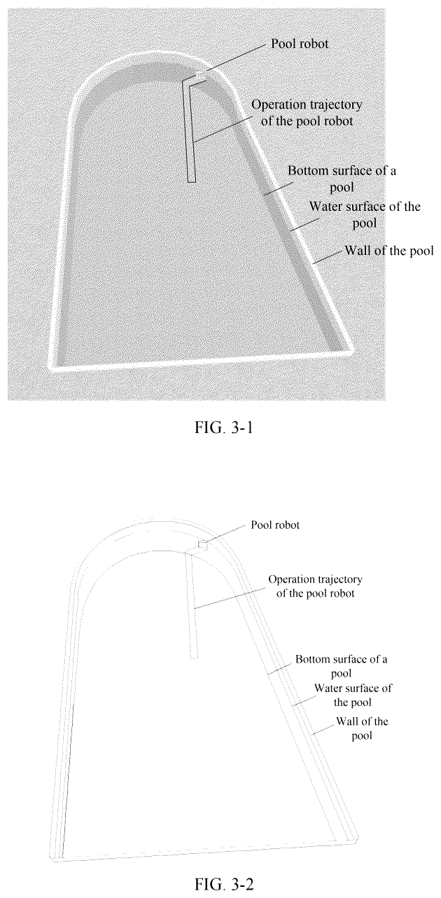

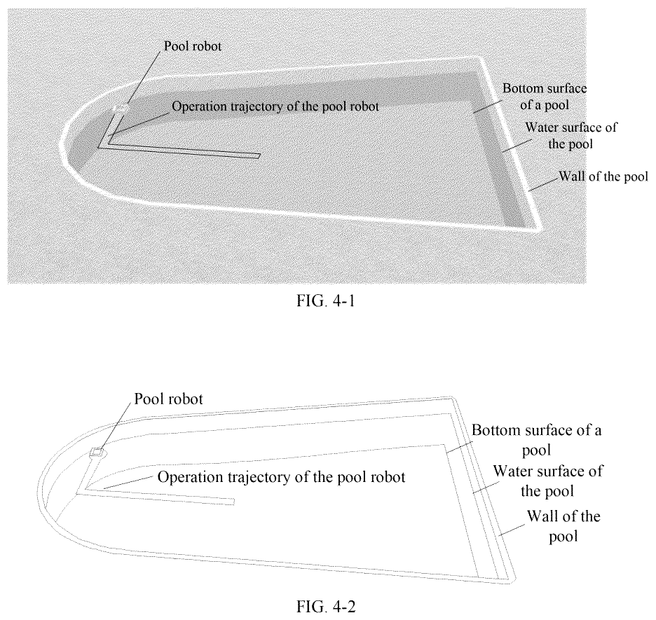

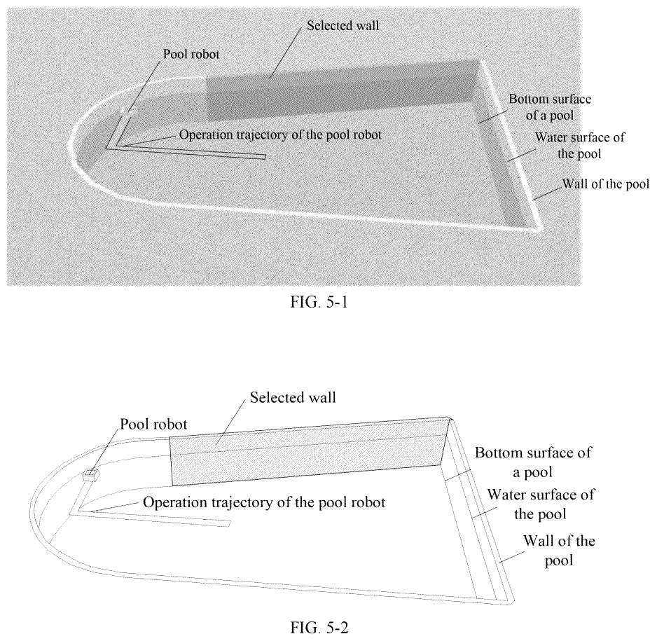

In an optional embodiment, the method further includes: obtaining position information of the pool robot when the pool robot operates in the pool; mapping the position information of the pool robot to the three-dimensional map of the pool to obtain path data of the pool robot in the three-dimensional map of the pool; processing the path data to generate a trajectory geometry whose thickness is less than a target quantity of pixel points; and rendering the trajectory geometry to obtain an operation trajectory of the pool robot in the three-dimensional map of the pool. In this embodiment, the path data may be processed by using a target geometry model stamping technology, and a width of the trajectory geometry may be determined based on a width of the pool robot. In the above embodiment, a two-dimensional or three-dimensional pool robot and the operation trajectory of the pool robot may be further rendered in the three-dimensional map. The operation trajectory of the pool robot is determined based on an actual motion path of the pool robot. Generally, a cleaning width of the pool robot is determined based on the width of the pool robot. Therefore, when the trajectory geometry of the pool robot is generated, pre-stored width data of the pool robot may be obtained, and then the trajectory of the pool robot is rendered based on the width data. In addition, considering that a height of the pool robot is less than that of the pool, the thickness of the trajectory of the pool robot may be set to be small, for example, one pixel point or two pixel points. When the trajectory of the pool robot is rendered, the geometry model stamping technology of Three. js may be used (certainly, other technologies may alternatively be used), an effect is created based on the processed path data (that is, data obtained when the pool robot moves may be processed through data analysis, coordinate transformation, texture mapping, and other manners), for example, an applying effect generated due to water filtering performed by the cleaning robot. The operation trajectory of the pool robot is rendered, so that the user can observe operation progress of the pool robot in real time. For the operation trajectory of the pool robot, refer to trajectories in FIG. 3-1, FIG. 3-2, FIG. 4-1, FIG. 4-2, FIG. 5-1, and FIG. 5-2. In this way, the user can intuitively know a cleaning progress and coverage area of the pool robot. This facilitates subsequent actions such as water use assessment, water discharge and exchange assessment, and other types of cleaning of the pool robot.

In the above embodiment, the Three. js technology may be used to create and render a three-dimensional scenario model, that is, the bottom of the pool, the wall of the pool, the water surface, environmental elements, and a model of the pool robot in the map of the pool can be rendered. For rendered diagrams of the map of the pool, refer to FIG. 3-1, FIG. 4-1, and FIG. 5-1. To more clearly illustrate components in the map of the pool, for corresponding line diagrams for the rendered diagrams of the map of the pool, respectively refer to FIG. 3-2, FIG. 4-2, and FIG. 5-2. According to a conventional solution of generating a map based on raster data, only a two-dimensional plane map can be generated. In addition, an APP of the pool robot on the market cannot display any form of map, failing to meet a user requirement, for example, for pool cleaning coverage and target region cleaning. Compared with the conventional solution of displaying the two-dimensional plane map, a solution of embodiments of this application can implement realistic display of the three-dimensional map of the pool. In this way, the user can observe and understand the structure and the layout of the pool more intuitively and realistically. In addition, according to embodiments of this application, the wall and the bottom of the pool can be observed and displayed from multiple dimensions. The user can freely select a specific region to observe and trigger the pool robot to clean the region directionally. In this way, the pool robot has a stronger directional cleaning capability.

In an optional embodiment, the mapping a plurality of pieces of two-dimensional coordinate information to a three-dimensional map to obtain target three-dimensional coordinate information includes: splitting target two-dimensional coordinate information included in the plurality of pieces of two-dimensional coordinate information to obtain a plurality of two-dimensional coordinate information groups, where the target two-dimensional coordinate information is grid information of a bottom surface edge of the pool, where the grid information is pre-detected by the pool robot; and mapping the plurality of two-dimensional coordinate information groups to the three-dimensional map to obtain target three-dimensional coordinate information corresponding to each two-dimensional coordinate information group, where a model generated based on the target three-dimensional coordinate information obtained by performing group mapping is capable of being rendered separately. In this embodiment, after the plurality of pieces of two-dimensional coordinate information are obtained, these pieces of two-dimensional coordinate information need to be split. During a splitting operation, two-dimensional coordinate information of an edge point on the bottom surface of the pool is mainly split. Considering that the bottom surface of the pool may not be a regular circle but rather in a regular or irregular shape with a straight line segment and/or a curved line segment, edge lines of the bottom surface of the pool need to be split. In other words, in this case, a splitting operation may be performed based on a type of a line segment on which the target two-dimensional coordinate information is located, and the plurality of two-dimensional coordinate information groups located on different line segments need to be obtained by performing the splitting operation. For example, each straight line segment and/or each curved line segment (namely, two-dimensional coordinate information of points located on each straight line segment and each curved line segment) are/is split out. In this way, wall models of the pool respectively corresponding to each straight line segment and each curved line segment on the edge of the bottom surface can be split out. Alternatively, the splitting operation may be performed based on a plane corresponding to the target two-dimensional coordinate information. For example, the plurality of two-dimensional coordinate information groups located on different walls of the pool may be obtained by performing the splitting operation. The splitting operation may alternatively be performed based on other preset requirements. For example, the plurality of two-dimensional coordinate information groups located on different blocks on a same wall may be obtained by performing the splitting operation. In addition, group mapping may be implemented after splitting is performed, so that block rendering can be subsequently performed on the wall model of the pool, and block selection can be implemented. It should be noted that the splitting operation in this application may be implemented through specific code or a specific splitting tool.

In an optional embodiment, the method further includes: receiving a selection instruction for the three-dimensional map; determining a target region in the pool according to the selection instruction; and controlling the pool robot to move to the target region and clean the target region. In this embodiment, the map of the pool may be observed by using a specific APP, and a region of the pool (for example, a wall of the pool, the bottom of the pool, or the water surface) may be selected by using the APP, to trigger a control instruction to control the pool robot to move to the selected region to operate. For a selection effect, refer to FIG. 5-1 and FIG. 5-2. The pool robot may be controlled to move to a specific position point at the selected region (for example, a center point of the region, a start point of an edge of the region, or a middle point of an edge of the region) or to move to a point at the selected region, where the point is closest to the pool robot.

In an optional embodiment, the mapping a plurality of pieces of two-dimensional coordinate information to a three-dimensional map includes: traversing the plurality of pieces of two-dimensional coordinate information to determine information of a second position point with a largest coordinate value and information of a third position point with a smallest coordinate value that are included in the plurality of pieces of two-dimensional coordinate information; determining a coordinate origin of the three-dimensional map of the pool based on information of a fourth position point located at a middle position between the second position point and the third position point; and mapping the plurality of pieces of two-dimensional coordinate information to the three-dimensional map based on a difference between each piece of two-dimensional coordinate information and the coordinate origin. In this embodiment, when the second position point and the third position point are determined, one of a plurality of world coordinate systems in which the robot is located when the robot detects a target position point may be used as a reference coordinate system, to obtain mapped coordinates of each position point mapped to the reference coordinate system. Then, one position point with a largest coordinate value and one position point with a smallest coordinate value may be obtained therefrom. In addition, because height (or depth) information of the second position point and height (or depth) information of the third position point are both known in advance, height (or depth) information of the fourth position point can be calculated naturally. In this way, position information of the coordinate origin determined based on the information of the fourth position point can be known. Then, a position of each position point in the three-dimensional map can be determined based on a coordinate difference between each position point and the coordinate origin. In this embodiment, the fourth position point may be directly determined as the coordinate origin, or the coordinate origin may be obtained by performing specific offset processing based on the fourth position point. In addition, a view angle of the three-dimensional map of the pool can be changed by mapping the position information. For example, a center point of the three-dimensional map of the pool under a three-dimensional view angle is used as a center point of the pool, to improve a generation effect of the map of the pool. Alternatively, before the three-dimensional map of the pool is generated, the raster data may be preprocessed. In other words, raster data such as terrain altitude data and pool structure data can be preprocessed and transformed to meet a requirement of a Three. js rendering engine. Preprocessing includes data analysis, coordinate transformation, texture mapping, and other operations.

A generation process of the map of the pool may be observed through an APP installed on a terminal. In addition, a user interaction function may be implemented through the APP. In other words, the user can freely browse and interact with the scenario: including operations such as rotation and zooming, so that the user can fully appreciate and experience the three-dimensional effect of the pool. In addition, the user interaction function allows the user to interact with the map of the pool, so that the user can select a specific region and trigger the pool robot to operate directionally. This improves a sense of participation of the user and improves spot cleaning flexibility and efficiency.

The following illustrates an overall procedure of this application by using an example in which the pool is a swimming pool, and the pool robot is a cleaning robot.

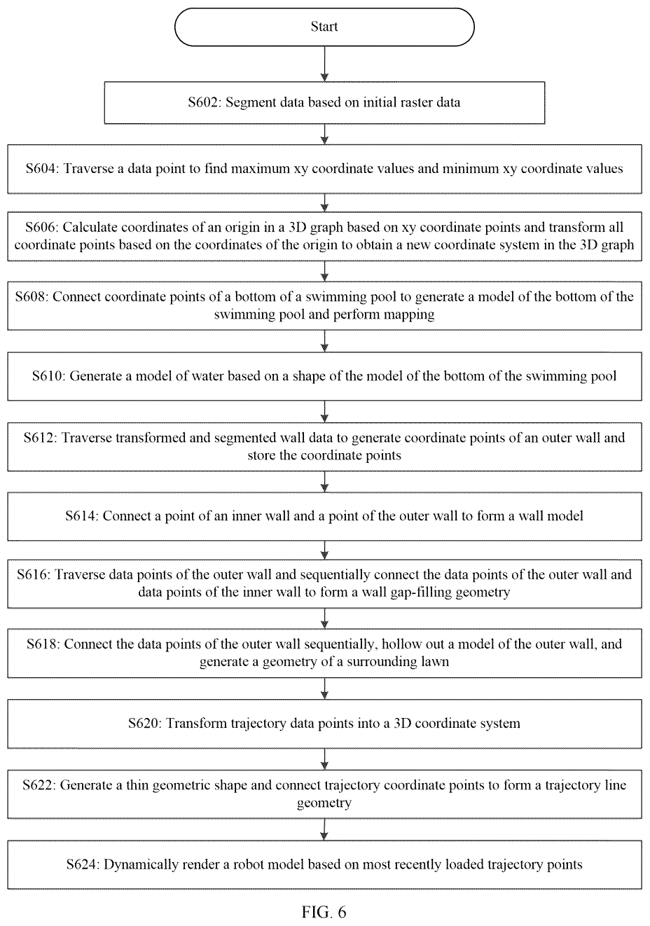

FIG. 6 is an overall flowchart according to an embodiment of this application. As shown in FIG. 6, the following steps are included.

S602: Segment data based on initial raster data of a swimming pool, where segmentation of the initial raster data mainly includes the following aspects: first, segmenting each line segment from an edge of the bottom of the swimming pool to facilitate subsequent block rendering of each wall model of the swimming pool; second, filtering out raster data that clearly does not belong to a position point in the swimming pool; and third, smoothing out outliers, that is, adjusting raster data of a position point in the swimming pool that slightly deviates.

S604: Traverse a data point to find maximum xy coordinate values and minimum xy coordinate values in a two-dimensional angle, where a traverse manner may include: sequentially traversing the segmented data or dividing the segmented data into blocks and then simultaneously traversing the data blocks; and comparing maximum coordinate values and minimum coordinate values found in the data blocks to determine final maximum coordinate values and minimum coordinate values.

S606: Calculate coordinates of an origin in a 3D graph based on xy coordinate points and transform all coordinate points based on the coordinates of the origin to obtain a new coordinate system in the 3D graph, where a middle point between the maximum xy coordinate values and the minimum xy coordinate values may be determined as a new coordinate origin, and the new coordinate origin is subtracted from all xy coordinate points to transform the xy coordinate points into coordinate points in a 3D scenario.

S608: Connect coordinate points of the bottom of the swimming pool to generate a model of the bottom of the swimming pool (namely, a bottom surface or the pool bottom) and perform mapping, where a mapping operation may be implemented through a rendering operation.

S610: Generate a model of water in the swimming pool based on a shape of the model of the bottom of the swimming pool.

S612: Traverse transformed and segmented wall (namely, a pool wall) data to generate coordinate points of an outer wall and store the coordinate points.

S614: Connect a point of an inner wall and a point of the outer wall to form a wall model.

S616: Traverse data points of the outer wall and sequentially connect the data points of the outer wall and data points of the inner wall to form a wall gap-filling geometry.

S618: Connect the data points of the outer wall sequentially to form a model of the outer wall, hollow out the model of the outer wall, and then generate a geometry of a surrounding lawn (an example in which the lawn surrounds the swimming pool is used).

S620: Transform trajectory data points of the swimming pool robot into a 3D coordinate system.

S622: Generate a thin geometric shape and connect trajectory coordinate points to form a trajectory line geometry, where the thin geometric shape may be a geometric shape with a thickness of one pixel point.

S624: Render a robot model based on most recently loaded trajectory points to generate a dynamic cleaning effect.

Based on the foregoing descriptions of the implementations, a person skilled in the art may clearly understand that the method in the above embodiments may be implemented by software in addition to a necessary universal hardware platform or by hardware only. In many cases, the former is a preferred implementation. Based on such understanding, the technical solutions of this application can be essentially or the part that contributes to the related technology can be embodied in a form of a software product. This computer software product is stored in a storage medium (for example, a ROM/RAM, a magnetic disk, or a compact disc), and includes several instructions for instructing a terminal device (which may be a mobile phone, a computer, a server, or a network device) to perform the method described in embodiments of this application.

An embodiment further provides a pool map generation apparatus. The apparatus is configured to implement the above embodiments and optional implementations. Some that have been described are not described in detail again. The term “module” used below may be a combination of software and/or hardware that implements a preset function. Although the apparatus described in the following embodiment is preferably implemented in software, it may be conceived that the apparatus is implemented in hardware or a combination of software and hardware.

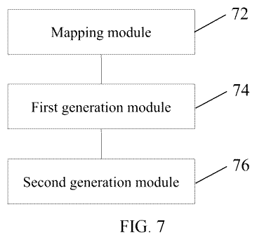

FIG. 7 is a block diagram of a structure of a pool map generation apparatus according to an embodiment of this application. As shown in FIG. 7, the apparatus includes: a mapping module 72 configured to map a plurality of pieces of two-dimensional coordinate information to a three-dimensional map to obtain target three-dimensional coordinate information, where each piece of two-dimensional coordinate information is grid information of a target position point in a pool, where the grid information is pre-detected by a pool robot; a first generation module 74 configured to generate a bottom model of the pool in the three-dimensional map of the pool based on bottom surface information of the pool included in the target three-dimensional coordinate information; and a second generation module 76 configured to generate a wall model and a water surface model of the pool in the three-dimensional map of the pool based on the bottom surface information.

In an optional embodiment, the first generation module 74 includes: a first connection unit configured to connect coordinate points corresponding to position information of adjacent edges included in the bottom surface information; a first generation unit configured to generate a bottom surface edge connection graph of the pool in the three-dimensional map of the pool based on a connection result; and a first rendering unit configured to render the bottom surface edge connection graph to obtain the bottom model.

In an optional embodiment, the second generation module 76 includes: an obtaining unit configured to obtain a distance between each first position point on a water surface and a bottom surface of the pool, where the distance is pre-detected by the pool robot; a second generation unit configured to generate a water surface connection graph of the pool in the three-dimensional map of the pool based on the distance between each first position point and the bottom surface of the pool; and a second rendering unit configured to render the water surface connection graph to obtain the water surface model.

In an optional embodiment, the second generation module 76 includes: a third generation unit configured to generate an inner wall model of the pool in the three-dimensional map of the pool based on the bottom surface information; and an extending-outward unit configured to extend the inner wall model outward in the three-dimensional map of the pool to generate the wall model of the pool in the three-dimensional map of the pool.

In an optional embodiment, the third generation unit includes: a determining sub-unit configured to determine an edge line of the pool in the three-dimensional map of the pool based on the bottom surface information; an extending sub-unit configured to extend the edge line upward by a preset height to generate a wall connection graph of the pool in the three-dimensional map of the pool; and a first rendering sub-unit configured to render the wall connection graph of the pool to obtain the inner wall model of the pool.

In an optional embodiment, the extending-outward unit includes: an extending-outward sub-unit configured to extend the inner wall model of the pool outward by a preset quantity of pixel points in the three-dimensional map of the pool to obtain an outer wall model of the pool; a connection sub-unit configured to connect a point on the inner wall model of the pool to a point on the outer wall model of the pool to form a wall gap-filling geometry; and a second rendering sub-unit configured to render the wall gap-filling geometry to obtain the wall model of the pool.

In an optional embodiment, the apparatus further includes: a connection unit configured to: after the wall model of the pool is generated, connect points on an outer side of the wall model of the pool to form an outer contour of a wall of the pool in the three-dimensional map of the pool; a fourth generation unit configured to hollow out the outer contour of the wall of the pool in the three-dimensional map of the pool to form a ground geometry located around the pool; and a third rendering unit configured to render the ground geometry to obtain a ground model located around the pool.

In an optional embodiment, the apparatus further includes: an obtaining module configured to obtain position information of the pool robot when the pool robot operates in the pool; a mapping module configured to map the position information of the pool robot to the three-dimensional map of the pool to obtain path data of the pool robot in the three-dimensional map of the pool; a processing module configured to process the path data to generate a trajectory geometry whose thickness is less than a target quantity of pixel points; and a second rendering module configured to render the trajectory geometry to obtain an operation trajectory of the pool robot in the three-dimensional map of the pool.

In an optional embodiment, the mapping module 72 includes: a splitting unit configured to split target two-dimensional coordinate information included in the plurality of pieces of two-dimensional coordinate information to obtain a plurality of two-dimensional coordinate information groups, where the target two-dimensional coordinate information is grid information of a bottom surface edge of the pool, where the grid information is pre-detected by the pool robot; and a first mapping unit configured to map the plurality of two-dimensional coordinate information groups to the three-dimensional map to obtain target three-dimensional coordinate information corresponding to each two-dimensional coordinate information group, where a model generated based on the target three-dimensional coordinate information obtained by performing grouping and mapping is capable of being rendered separately.

In an optional embodiment, the apparatus further includes: a receiving module configured to receive a selection instruction for the three-dimensional map; a determining module configured to determine a target region in the pool according to the selection instruction; and a control module configured to control the pool robot to move to the target region and clean the target region.

In an optional embodiment, the mapping module 72 includes: a first determining unit configured to traverse the plurality of pieces of two-dimensional coordinate information to determine information of a second position point with a largest coordinate value and information of a third position point with a smallest coordinate value that are included in the plurality of pieces of two-dimensional coordinate information; a second determining unit configured to determine a coordinate origin of the three-dimensional map of the pool based on information of a fourth position point located at a middle position between the second position point and the third position point; and a second mapping unit configured to map the plurality of pieces of two-dimensional coordinate information to the three-dimensional map based on a difference between each piece of two-dimensional coordinate information and the coordinate origin.

It should be noted that each module may be implemented by software or hardware, and for the latter, it may be implemented in the following manner: All modules are located in a same processor, or various modules are located in different processors respectively in a form of any combination. However, this is not limited thereto.

An embodiment of this application further provides a computer-readable storage medium. The computer-readable storage medium stores a computer program. When the computer program is run, steps in any one of the method embodiments are performed.

In some embodiments, the computer-readable storage medium may include, but is not limited to, any medium that can store the computer program, for example, a USB flash drive, a read-only memory (Read-Only Memory, ROM), a random access memory (Random Access Memory, RAM), a removable hard disk, a magnetic disk, or a compact disc.

An embodiment of this application further provides an electronic device. The electronic device includes a memory and a processor. The memory stores a computer program. The processor is configured to: when executing the computer program, perform steps in any one of the method embodiments.

In some embodiments, the electronic device may further include a transmission device and an input/output device. The transmission device is connected to the processor, and the input/output device is connected to the processor.

For details of specific examples in this embodiment, refer to the examples described in the above embodiments and example implementations. Details are not described in this embodiment again.

It is clear that a person skilled in the art should understand that the modules or steps in this application may be implemented by a general-purpose computing apparatus, and the modules may be integrated on a single computing apparatus or distributed on a network including a plurality of computing apparatuses, or may be implemented by program code executed by a computing apparatus. In this way, the program code can be stored in a storage apparatus and executed by the computing apparatus. In addition, in some cases, the shown or described steps may be performed in an order different from the above order, or the modules are respectively manufactured into various integrated circuit modules, or a plurality of modules are manufactured into a single integrated circuit module. In this way, this application is not limited to any particular combination of hardware and software.

The foregoing descriptions are merely optional embodiments of this application, and are not intended to limit this application. For a person skilled in the art, this application may have various modifications and variations. Any modification, equivalent replacement, improvement, or the like made without departing from the principle of this application shall fall within the protection scope of this application.

What is claimed is:

1. A pool robot control method, comprising:
receiving a selection instruction for a three-dimensional map of a pool, wherein the three-dimensional map of the pool comprises a bottom model of the pool, a wall model of the pool, and a water surface model;
determining a target region in the pool based on the selection instruction; and
controlling a pool robot to move to the target region and clean the target region.

2. The method according to claim 1, wherein the controlling a pool robot to move to the target region comprises:
controlling the pool robot to move to a specific position point in the target region, wherein the specific position point comprises one of the following:
a center point of the target region, a start point of one edge of the target region, a middle point of one edge of the target region, and a position point in the target region, wherein the position point is closest to a current position of the pool robot.

3. The method according to claim 1, further comprising:
receiving a selection instruction for the wall model of the pool and/or the bottom model of the pool; and
controlling the pool robot to move to a wall of the pool corresponding to the wall model of the pool and/or a bottom of the pool corresponding to the bottom model of the pool and clean the wall of the pool and/or the bottom of the pool.

4. The method according to claim 1, further comprising displaying a generation process of the three-dimensional map of the pool and/or the three-dimensional map of the pool on a terminal.

5. The method according to claim 1, further comprising rendering a two-dimensional or three-dimensional model of the pool robot in the three-dimensional map of the pool.

6. The method according to claim 1, wherein the wall model of the pool is flush with or higher than the water surface model.

7. The method according to claim 1, further comprising displaying the three-dimensional map of the pool and a ground model on a terminal, wherein the ground model is located around the three-dimensional map of the pool.

8. The method according to claim 7, further comprising:
connecting points on an outer side of the wall model of the pool to form an outer contour of a wall of the pool in the three-dimensional map of the pool;
hollowing out the outer contour of the wall of the pool in the three-dimensional map of the pool to form a ground geometry located around the three-dimensional map of the pool; and
rendering the ground geometry to obtain the ground model; or
extending a top surface of the wall model of the pool outward to obtain the ground model.

9. The method according to claim 7, wherein a top surface of the ground model is flush with or lower than a top surface of the wall model of the pool.

10. The method according to claim 1, further comprising rendering an operation trajectory of the pool robot in the three-dimensional map of the pool, wherein the operation trajectory of the pool robot is determined based on an actual motion path of the pool robot.

11. The method according to claim 10, wherein the rendering an operation trajectory of the pool robot in the three-dimensional map of the pool comprises:
obtaining position information of the pool robot when the pool robot operates in the pool;
mapping the position information of the pool robot to the three-dimensional map of the pool to obtain path data of the pool robot in the three-dimensional map of the pool; and
generating a trajectory geometry based on the path data and rendering the trajectory geometry to obtain the operation trajectory of the pool robot in the three-dimensional map of the pool.

12. The method according to claim 11, wherein the generating a trajectory geometry based on the path data comprises processing the path data based on a height of the pool robot to generate the trajectory geometry whose thickness is less than a preset thickness.

13. The method according to claim 1, further comprising:
generating the bottom model of the pool based on bottom surface information of the pool, wherein the bottom surface information comprises position information of an edge of a bottom of the pool; and
generating the wall model of the pool and the water surface model based on the bottom surface information.

14. The method according to claim 13, wherein the generating the bottom model of the pool based on bottom surface information of the pool comprises:
connecting coordinate points corresponding to position information of adjacent edges comprised in the bottom surface information;
generating a bottom surface edge connection graph of the pool in the three-dimensional map of the pool based on a connection result; and
rendering the bottom surface edge connection graph to obtain the bottom model of the pool.

15. The method according to claim 13, wherein the generating the water surface model based on the bottom surface information comprises:
obtaining a distance between each first position point on a water surface and a bottom surface of the pool, wherein the distance is pre-detected by the pool robot;
generating a water surface connection graph of the pool in the three-dimensional map of the pool based on the distance between each first position point and the bottom surface of the pool; and
rendering the water surface connection graph to obtain the water surface model.

16. The method according to claim 13, wherein the generating the water surface model based on the bottom surface information comprises:
obtaining depth information of each position point on a bottom surface of the pool, wherein the depth information is pre-detected by the pool robot;
obtaining a position point on a water surface of the pool based on the depth information and the bottom surface information and generating a water surface connection graph of the pool in the three-dimensional map of the pool based on the position point on the water surface; and
rendering the water surface connection graph to obtain the water surface model.

17. The method according to claim 13, wherein the generating the wall model of the pool based on the bottom surface information comprises:
generating an inner wall model of the pool in the three-dimensional map of the pool based on the bottom surface information; and
extending the inner wall model of the pool outward in the three-dimensional map of the pool to generate the wall model of the pool in the three-dimensional map of the pool.

18. The method according to claim 17, wherein the generating an inner wall model of the pool in the three-dimensional map of the pool based on the bottom surface information comprises:
determining an edge line of the pool in the three-dimensional map of the pool based on the bottom surface information;
extending the edge line upward by a preset height to generate a wall connection graph of the pool in the three-dimensional map of the pool; and
rendering the wall connection graph of the pool to obtain the inner wall model of the pool.

19. The method according to claim 17, wherein the extending the inner wall model of the pool outward in the three-dimensional map of the pool to generate the wall model of the pool in the three-dimensional map of the pool comprises:
extending the inner wall model of the pool outward by a preset distance in the three-dimensional map of the pool to obtain an outer wall model of the pool;
connecting a point on the inner wall model of the pool to a point on the outer wall model of the pool to form a wall gap-filling geometry; and
rendering the wall gap-filling geometry to obtain the wall model of the pool.

20. The method according to claim 19, wherein before the inner wall model of the pool is extended outward by the preset distance in the three-dimensional map of the pool, the method further comprises:
determining a width of the pool in the three-dimensional map of the pool; and
determining the preset distance based on a preset proportion of the width.
